(19) United States
(12) Patent Application Publication
(10) Pub. No.: US 2024/0418252 A1
(43) Pub. Date: Dec. 19, 2024

(54) GEAR ARRANGEMENT

(71) Applicant: AKTIEBOLAGET SKF, GOTEBORG (SE)

(72) Inventor: Ingo SCHULZ, Gerolzhofen (DE)

(21) Appl. No.: 18/695,081

(22) PCT Filed: Sep. 19, 2022
(86) PCT No.: PCT/EP2022/075925

§ 371 Date: Mar. 25, 2024

(30) Foreign Application Priority Data
Sep. 30, 2021 (DE) 10 2021 211 021.5

(51) Int. Cl. F16H 57/08; F16D 1/072; F16H 57/00

(52) U.S. Cl. CPC F16H 57/0025; F16D 1/072

(57) ABSTRACT

A shaft-and-gear arrangement includes a shaft having a longitudinal axis of rotation, a first portion having an outer diameter, a second portion, and a third portion axially between the first portion and second portions. A first gear is formed either integrally with the second portion of the shaft or has a circumferential inner surface secured to an outer surface of the second portion of the shaft. The first gear has a first subportion having a maximum outer diameter of the first gear and a second subportion having a radially outer surface having a maximum outer diameter less than the maximum outer diameter of the first gear, and the second subportion includes a first axially facing abutment surface. The second gear also has a first subportion and a second subportion with a second axially facing abutment surface in contact with the first axially facing abutment surface.

The present invention relates to a gear arrangement according to the preamble of patent claim 1. The present invention further relates to a method for producing such a gear arrangement according to the preamble of patent claim 8.

Gear arrangements, such as, for example, high-precision gear arrangements, such as planetary gear mechanisms, may have different force-transmitting elements. These may be gears, such as, for example, planetary gears. In order to transmit a torque from one force-transmitting element to another, they can be connected to each other, as is the case, for example, with the planetary gears of a double planetary gear mechanism. The connection of a first and a second force-transmitting element in such a gear arrangement must be configured so that a high torque can be transmitted, but at the same time the force-transmitting elements are not negatively influenced.

Such a high torque can, for example, lead to high circumferential stresses and therefore to cracks in the force-transmitting elements, particularly in tooth bases of toothed wheels. Furthermore, at the same time such a connection of two force-transmitting elements must be very rigid in the torsion direction in order to be able to be used in a high-precision gear mechanism. Currently used connections of two force-transmitting elements in a gear arrangement are configured in such a manner that either the force-transmitting elements thereby become very cost-intensive, for example, as a result of the material used, or the diameter of the force-transmitting element must be increased for such a connection, whereby more space is required in the gear arrangement and this arrangement thereby becomes larger.

Such connections between force-transmitting elements can be produced by a radial press-fit, welding, etc. However, the known connections have a number of disadvantages. Thus, for example, welding is cost-intensive and has a thermal influence on the elements, which may lead to a change of the material properties. For high torques, a press-fit over the radial face requires a great diameter of the force-transmitting elements, wherein at the same time limits have to be considered in the circumferential stresses at the external diameter of a hub portion of the gear arrangement, which in turn leads to lower rigidity in the rotation direction. A press-fit over the axial face, that is to say, as a bolt/flange connection, again requires a large diameter for bolts. Wedge connections over the radial face or axial face are cost-intensive and do not allow a relative movement between the connection members during assembly. Another possibility involves the force-transmitting elements being adhesively bonded, but this only provides the connection with a low strength.

Therefore, an object of the present invention is to provide a connection between force-transmitting elements of a gear arrangement, by which a reliable and stable coupling of the elements which is suitable for high torques and at the same time cost-effective to produce can be ensured.

This object is achieved by a gear arrangement according to patent claim 1 and a method for producing such a gear arrangement according to patent claim 8.

The gear arrangement has at least a first and a second force-transmitting element which are arranged coaxially on a shaft and which are configured to transmit a torque. The gear arrangement may be particularly a high-precision gear mechanism. The first and second force-transmitting elements may be any type of force-transmitting elements which are arranged coaxially on a shaft, such as, for example, gears. For example, the force-transmitting elements may be the two planetary gears of a double planetary gear mechanism in a planetary gear mechanism.

The first and second force-transmitting elements each have an internal circumferential face. The second force-transmitting element is fitted onto the shaft with the internal circumferential face and is coupled to the shaft by means of a radial fit.

The first force-transmitting element can be configured separately from the shaft and, similarly to the second force-transmitting element, can be fitted onto the shaft with an internal circumferential face and coupled thereto by means of a radial fit. Alternatively, the first force-transmitting element can be integrally configured with the shaft. In this case, therefore, the second force-transmitting element is also fitted onto the first force-transmitting element during fitting onto the shaft. If the first force-transmitting element is integrally configured with the shaft, the shaft can be in the form of a mushroom-like shaft or bell-like shaft.

The radial fit can be in the form of a press-fit which is achieved with the shaft, for example, by an over-dimension between the internal circumferential faces of the first and/or second force-transmitting elements. Alternatively, the radial fit may also be in the form of a clearance fit. In this case, the first and/or second force-transmitting elements can be secured to the shaft by a material engagement, for example, by using adhesive or the like.

In order to produce a particularly stable connection, which can transmit a high torque, between the first and the second force-transmitting elements, the first force-transmitting element is additionally coupled to the second force-transmitting element at a respective abutment face, which abut each other in an axial direction, via an axial frictional engagement. This means that the connection between the first and second force-transmitting elements is produced with respect to each other both via a radial fit with respect to the shaft and via an axial frictional engagement. This connection is suitable for transmitting a torque with the shaft via the axial face between the two force-transmitting elements and, depending on the configuration of the radial fit, also via the radial face. In particular, during a transmission of the torque both via the radial face with the shaft and the axial face between the two force-transmitting elements, two loading paths, that is to say, an axial loading path and a radial loading path, which do not overload the individual elements and, for example, do not produce any excessively high circumferential stresses in the radial connection, are produced.

The first and second force-transmitting elements can further be connected to each other via a securing element. The securing element may, for example, be a stop ring, a nut, a grooved nut, a bolt, a flanging or the like, or a combination thereof, which are suitable for securing the first and second force-transmitting elements to each other.

The abutment faces, which abut each other in an axial direction, of the first and second force-transmitting elements which are coupled via an axial frictional engagement transmit a torque and allow the torsional rigidity to be determined either only by the radial internal circumferential face or only by the axial abutment faces, or allow the torsional rigidity to be determined both by the radial internal circumferential face and the axial abutment faces. Preferably, a diameter of the force-transmitting elements which can transmit a great torque can be selected here.

Since the connection between the first and second force-transmitting elements is produced with respect to each other and the shaft without any heat, that is to say, not by welding or the like, but instead by fitting and frictional engagement, the material properties of the individual elements are therefore not negatively affected. Furthermore, the connection between the first and second force-transmitting elements and with respect to the shaft during the assembly can be produced simply by positioning the elements relative to each other and the mounting thereof without the elements of the gear arrangement further having to be guided onward to another processing apparatus, such as a welding station or the like. Consequently, the production of the gear arrangement can be simplified and is more cost-effective in comparison with previous gear arrangements.

In order to improve the connection between the individual members and in particular in order to increase the load capacity of the force-transmitting elements, that is to say, the internal circumferential faces and the abutment faces, they can be provided with friction-increasing means. The friction-increasing means may particularly be any surface treatments which increase the friction coefficient. Such friction-increasing means may have, for example, a friction-increasing layer, for example, an adhesive layer or a zinc layer, or friction-increasing particles, for example, particles which have a higher hardness than the material of the force-transmitting elements or a combination thereof.

According to one embodiment, the internal circumferential face of the first and/or second force-transmitting element are conical faces. In this case, the corresponding face of the shaft which is provided either as a separate element or as an integral element of the first force-transmitting element may also be conical. Such conical faces particularly simplify the fitting of the respective force-transmitting element onto the shaft, particularly in the case of a press-fit.

Alternatively, the internal circumferential faces of the first and/or second force-transmitting elements may be cylindrical faces. Furthermore, a combination of conical faces and cylindrical faces is also possible, wherein the internal circumferential face of the first force-transmitting element may be a conical face and the internal circumferential face of the second force-transmitting element may be a cylindrical face, or vice versa.

A cylindrical face further allows the radial fit to be in the form of a transition fit or clearance fit so that the portion of the force or torque transmission can be transmitted gradually up to 100% to the axial frictional engagement. Such a clearance fit can be fixed by an adhesive.

In order also to ensure the axial frictional engagement between the first and second force-transmitting elements during operation, a force-applying means which is configured to apply an axial force, which acts in the direction of the abutment faces between the first and second force-transmitting elements, to the first and/or second force-transmitting elements can be provided. This force is used to produce the frictional engagement between the first and second force-transmitting elements. The force-applying element can simultaneously act as a securing means as described above in order to maintain the axial force. The force-applying means may be any type of means which is used to apply the force and/or to maintain it. For example, the force-applying means may be a stop ring, a nut, a grooved nut, a bolt or the like, or a combination thereof. Furthermore, it is also possible to initially apply a force to the two force-transmitting elements and subsequently to connect the two force-transmitting elements to each other in this state by means of flanging or the like, wherein in this case the force-applying means is the flange.

According to another aspect, a method for producing a gear arrangement as described above is proposed. The method has the following steps: applying the first and second force-transmitting elements to the shaft, in particular by applying an axial force in the direction of the axial abutment faces, joining the first and second force-transmitting elements to the shaft by radial fitting and connecting the first force-transmitting element to the second force-transmitting element in a frictionally engaging manner at the abutment faces via an axial frictional engagement.

The axial force can be used both to join the first and second force-transmitting elements to the shaft and to produce the axial fictional engagement. This axial force may, for example, press the second force-transmitting element onto a cylindrical or conical region of the first force-transmitting element which constitutes the shaft. Alternatively, the axial force can press both the first force-transmitting element and the second force-transmitting element onto the shaft. For example, the radial fit may be in the form of a press-fit as a result of an over-dimension between the internal circumferential faces and the shaft between the shaft and the first and/or second force-transmitting elements. In the end position of the first and second force-transmitting elements, the respective abutment faces of the elements touch each other. This in turn produces the axial frictional engagement. Both the radial fit and the axial frictional engagement now transmit a torque load between the first and second force-transmitting elements.

According to one embodiment, the method further has a rotation of the first force-transmitting element with respect to the second force-transmitting element after the joining and before the frictionally engaging connection of the first and second force-transmitting elements as a result of the axial frictional engagement. If the frictional engagement between the two elements does not yet exist, it is possible to rotate the force-transmitting elements about the axis thereof. Consequently, they can be positioned relative to each other in any desired angular position. For example, a play can thereby be reduced between the tooth arrangements of planetary gears of a double planetary gear mechanism and a hollow shaft and/or a sun gear in a planetary gear mechanism.

Additional advantages and advantageous embodiments are set out in the description, the drawings and the claims. In this case, the combinations, which are set out in the description and the drawings, of the features are merely by way of example so that the features can also be present individually or in a state combined in a different manner.

The invention is intended to be described in greater detail below with reference to exemplary embodiments which are illustrated in the drawings. In this case, the exemplary embodiments and the combinations which are set out in the exemplary embodiments are merely by way of example and are not intended to determine the scope of protection of the invention. This scope is defined only by the appended claims.

In the drawings:

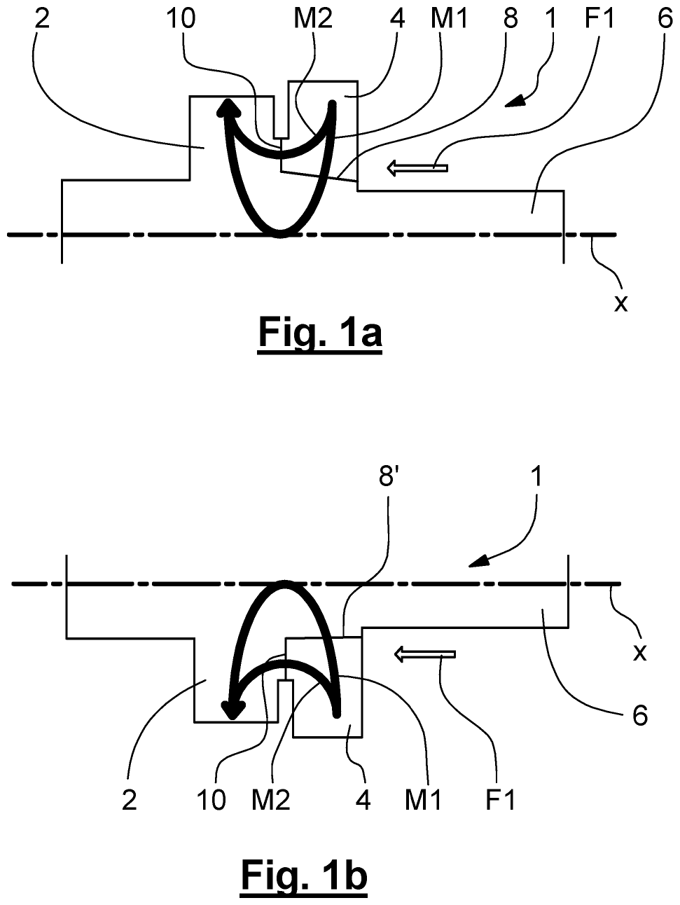

FIG. 1a: shows a schematic sectioned view of a gear arrangement having a first and a second force-transmitting element according to a first embodiment;

FIG. 1b: shows a schematic sectioned view of a gear arrangement having a first and a second force-transmitting element according to a second embodiment;

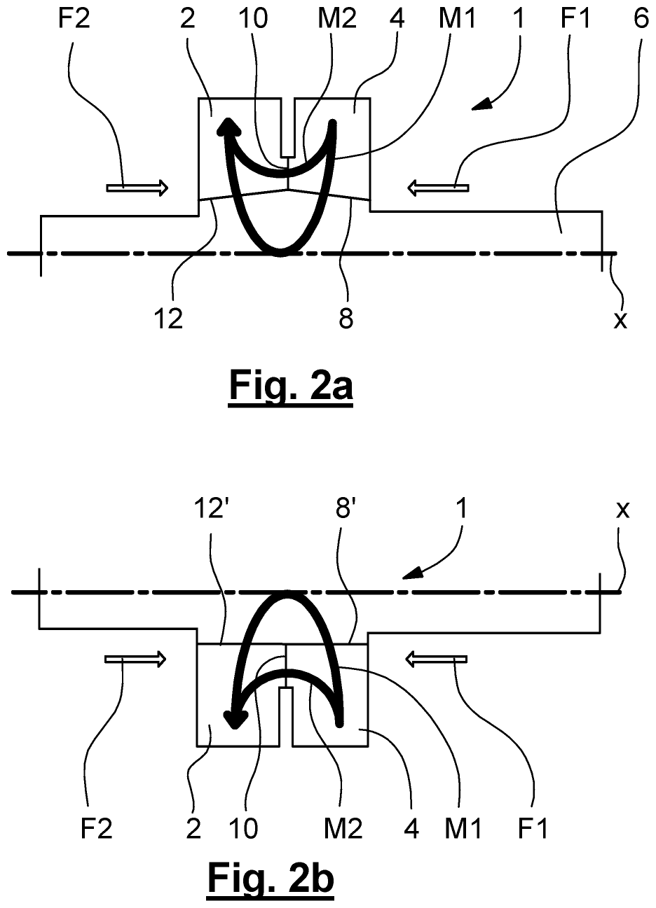

FIG. 2a: shows a schematic sectioned view of a gear arrangement having a first and a second force-transmitting element according to a third embodiment; and

FIG. 2b: shows a schematic sectioned view of a gear arrangement having a first and a second force-transmitting element according to a fourth embodiment.

Identical or functionally equivalent elements are indicated below with the same reference numerals.

FIGS. 1a, 1b, 2a, 2b show a gear arrangement 1 which has a first force-transmitting element 2 and a second force-transmitting element 4. The two force-transmitting elements 2, 4 may be, for example, two planetary gears of a double planetary gear mechanism.

The two force-transmitting elements 2, 4 are coaxially arranged on a shaft 6 with a rotation axis X. In the embodiments shown in FIGS. 1a and 1b, the first force-transmitting element 2 is integrally formed with the shaft 6 and can, for example, constitute a mushroom-like shaft. Alternatively, the first force-transmitting element 2 in the embodiments shown in FIGS. 2a and 2b is in the form of an element separate from the shaft 6.

In order to transmit a torque M1, M2, the first force-transmitting element 2 and the second force-transmitting element 4 are connected not only to the shaft 6 but also to each other. To this end, initially the second force-transmitting element 4 is fitted on the shaft 6 or the portion, which forms the shaft 6, of the first force-transmitting element 2. During the fitting of the second force-transmitting element 4, a fit between the second force-transmitting element 4 at the internal circumferential face 8, 8′ of the second force-transmitting element 4 and the corresponding face of the shaft 6 (or of the first force-transmitting element 2) is brought about. The radial fit can preferably be a press-fit, wherein a clearance fit is also possible.

This internal circumferential face 8, 8′ may be produced either as a cylindrical internal circumferential face 8′, as illustrated in FIG. 1a, or as a conical internal circumferential face 8, as illustrated in FIG. 1b. The corresponding face of the shaft 6 has a shape which is complementary.

If an axial force F1 now acts on the second force-transmitting element 4, it is pressed at an abutment face 10 against a corresponding abutment face 10 of the first force-transmitting element 2. At the abutment faces 10 between the first force-transmitting element 2 and the second force-transmitting element 4, a frictional engagement between the two elements 2, 4 is achieved. The axial force F1 can be maintained during operation by suitable force-applying means, such as, for example, a grooved nut or the like (not illustrated).

As a result of the connection between the first force-transmitting element 2 and the second force-transmitting element 4 both via the radial fit at the internal circumferential face 8, 8′ and the frictional engagement at the abutment faces 10, the two force paths M1, M2 which are illustrated by corresponding arrows are reached. In this case, M1 constitutes a radial force or torque path and M2 constitutes an axial force and torque path. The main force or torque transmission takes place in this case via the path M2 at the abutment faces 10.

As already explained above, the first force-transmitting element 2 can also be formed as an element which is separate from the shaft 6, as shown in FIGS. 2a and 2b. In this case, the first force-transmitting element 2 is fitted similarly to the force-transmitting element 4 on the shaft 6 by means of a fit, for example, a press-fit, at the internal circumferential faces 12, 12′. They can, similarly to the internal circumferential face 8, 8′, be in the form of a conical internal circumferential face 12 (FIG. 2a) or a cylindrical internal circumferential face 12′ (FIG. 2b). In this case, the frictional engagement between the first and the second force-transmitting elements 2, 4 at the abutment faces 10 is achieved by axially acting forces F1, F2 which act from both axial sides on the two force-transmitting elements 2, 4. As already explained above, the axial forces F1, F2 can be maintained by corresponding force-applying means during operation.

As a result of the above-described gear arrangement, it is possible to provide a simple and stable connection between a first and a second force-transmitting element, wherein an axial and preferably also a radial force-transmission path is enabled. This in turn results in the individual members of the gear arrangement not being overloaded and consequently increases the service-life of the gear arrangement.

### LIST OF REFERENCE NUMERALS

1 Gear arrangement
2 First force-transmitting element
4 Second force-transmitting element
6 Shaft
8 Internal circumferential face
10 Abutment faces
12 Internal circumferential face
F1, F2 Axial force
M1, M2 Force transmission path
X Rotation axis

1-10. (canceled)

11. A shaft-and-gear arrangement comprising:
a shaft having a longitudinal axis of rotation, a first portion having an outer diameter, a second portion, and a third portion axially between the first portion and the second portion,
a first gear formed integrally with the second portion of the shaft or having a circumferential inner surface secured to an outer surface of the second portion of the shaft, the first gear having a first subportion having a maximum outer diameter of the first gear and a second subportion having a radially outer surface having a maximum outer diameter less than the maximum outer diameter of the first gear, the second subportion including a first axially facing abutment surface, and
a second gear having a circumferential inner surface mounted on the third portion of the shaft coaxial with the first gear, the second gear having a first subportion having a maximum outer diameter of the second gear and a second subportion having a radially outer surface having a maximum outer diameter less than the maximum outer diameter of the second gear, the second subportion having a second axially facing abutment surface in contact with the first axially facing abutment surface of the first gear.

12. The shaft-and-gear arrangement according to claim 11,
wherein the first gear is formed integrally with the shaft.

13. The shaft-and-gear arrangement according to claim 12,
wherein the third portion of the shaft has either: a) a conical outer surface having a minimum outer diameter greater than the outer diameter of the first portion of the shaft and a maximum outer diameter less than the maximum outer diameter of the second subportion of the first gear or b) a cylindrical outer surface having an outer diameter greater than the outer diameter of the first portion of the shaft and less than the maximum outer diameter of the second subportion of the first gear.

14. The shaft-and-gear arrangement according to claim 13,
wherein the third portion of the shaft has the cylindrical outer surface.

15. The shaft-and-gear arrangement according to claim 13,
wherein the third portion of the shaft has the conical outer surface.

16. The shaft-and-gear arrangement according to claim 13,
wherein the second gear is mounted to the third portion of the shaft with a press fit.

17. The shaft-and-gear arrangement according to claim 13,
wherein a friction increasing coating and/or friction increasing particles are applied to at least one surface selected from the group consisting of: the circumferential inner surface of the second gear, the first axially facing abutment surface and the second axially facing abutment surface.

18. The shaft-and-gear arrangement according to claim 13,
wherein the first gear has the circumferential inner surface secured to the outer surface of the second portion of the shaft.

19. The shaft-and-gear arrangement according to claim 18,
wherein the third portion of the shaft has either: a) a conical outer surface having a minimum outer diameter greater than the outer diameter of the first portion of the shaft and a maximum outer diameter less than the maximum outer diameter of the second subportion of the first gear or b) a cylindrical outer surface having an outer diameter greater than the outer diameter of the first portion of the shaft and less than the maximum outer diameter of the second subportion of the first gear.

20. The shaft-and-gear arrangement according to claim 19,
wherein the third portion of the shaft has the cylindrical outer surface.

21. The shaft-and-gear arrangement according to claim 19,
wherein the third portion of the shaft has the conical outer surface.

22. The shaft-and-gear arrangement according to claim 21,
wherein the second portion of the shaft has a conical outer surface angled away from the first portion of the shaft, and
wherein the conical outer surface of the third portion of the shaft is angled toward the first portion of the shaft.

23. The shaft-and-gear arrangement according to claim 19,
wherein the second portion of the shaft has a cylindrical outer surface, and
wherein the third portion of the shaft has the cylindrical outer surface.

24. The shaft-and-gear arrangement according to claim 23,
wherein the outer diameter of the second portion of the shaft is the same as the outer diameter of the third portion of the shaft.

25. The shaft-and-gear arrangement according to claim 19,
wherein a friction increasing coating and/or friction increasing particles are applied to at least one surface selected from a group consisting of: the circumferential inner surface of the first gear, the circumferential inner surface of the second gear, the first axially facing abutment surface and the second axially facing abutment surface.

26. The shaft-and-gear arrangement according to claim 19,
wherein the first gear is mounted to the second portion of the shaft with a press fit and the second gear is mounted to the third portion of the shaft with a press fit.
